(19) United States
(12) Patent Application Publication
(10) Pub. No.: US 2026/0064126 A1
(43) Pub. Date: Mar. 5, 2026

(54) OPTIMIZING REAL-TIME TERRAIN CLASSIFICATION FOR ROBOTIC DEPLOYMENT IN ADVERSE OPERATIONAL CONDITIONS

(71) Applicant: Field AI, Inc., Mission Viejo, CA (US)

(72) Inventors: David FAN, Lake Forest, CA (US); Aliakbar AGHAMOHAMMADI, Mission Viejo, CA (US); Amirreza SHABAN, Seattle, WA (US); Sunggoo JUNG, Irvine, CA (US); Dong Ki KIM, Cambridge, MA (US)

(73) Assignee: Field AI, Inc., Mission Viejo, CA (US)

(21) Appl. No.: 19/320,788

(22) Filed: Sep. 5, 2025

Related U.S. Application Data
(60) Provisional application No. 63/690,824, filed on Sep. 5, 2024.

(51) Int. Cl. G05D 1/617; G05D 1/246; G05D 101/15

(52) U.S. Cl. CPC G05D 1/617; G05D 1/246; G05D 2101/15

(57) ABSTRACT

Systems and methods for real-time terrain classification via an autonomous robot are provided. An example method may obtain environmental data indicating one or more characteristics of a physical environment including terrain, and classify the terrain based upon the environmental data. Based upon a first classification of the terrain, the method may determine a terrain assessment task associated with reclassifying at least the portion of the terrain and determine whether performing the terrain assessment task will exceed a performance threshold indicating an adverse effect on performing a mission task. Based upon determining whether performing the terrain assessment task will exceed the performance threshold, the method may generate terrain assessment task configuration data for configuring the autonomous robot and transmit the terrain assessment task configuration data to the autonomous robot causing configuration of the autonomous robot associated with the terrain assessment task.

### CROSS-REFERENCE TO RELATED APPLICATION

This application claims priority to and the benefit of the filing date of provisional U.S. Patent Application No. 63/690,824, entitled “SYSTEM AND METHOD FOR OPTIMIZING REAL-TIME TERRAIN CLASSIFICATION FOR ROBOTIC DEPLOYMENT IN ADVERSE OPERATIONAL CONDITIONS” and filed on Sep. 5, 2024, the entire contents of which is hereby expressly incorporated herein by reference.

### TECHNICAL FIELD

The implementations of the present disclosure relate to robotic navigation, and specifically to a system and method for real-time terrain classification via an autonomous robot.

### BACKGROUND

Robotic environmental exploration and terrain classification may present significant challenges associated with the deployment of robots in unexplored and/or unstructured environments, such as disaster zones, extraterrestrial terrains, and deep-sea exploration sites. The unexplored and/or unstructured environments may be unpredictable, include one or more hazards, and/or may lack predefined mappings and reliable infrastructure. A primary concern in such deployments is ensuring safety of the robot while allowing the robot to carry out its tasks effectively. The ability to autonomously navigate and interact with complex terrains without compromising the safety of the robot is critical for completion of their tasks.

An autonomous robot may rely on one or more sensors (e.g., onboard, remote) and computational means (e.g., algorithms, models) to perceive and understand its surroundings. However, in the unstructured environments the sensors may sense and/or the autonomous robot may otherwise encounter terrain types that are unknown, such as environments which the autonomous robot has not previously encountered during training or configuration, and/or is unable to identify. The autonomous robot may classify the terrain into safety categories (e.g., safe, unsafe, unknown safety) respective to the robot to determine a path of navigation in the environment. Misclassifying hazardous terrain as safe can lead to catastrophic failures, such as causing the autonomous robot to be unable to traverse the terrain, causing damage to the autonomous robot, causing an inability of the autonomous robot to perform tasks, etc. The complexity of the environment, coupled with limited prior knowledge of the environment and/or its terrain, can cause the task of safe navigation by the robot in the environment to be particularly daunting.

One solution to these problems is map-based navigation, where the autonomous robot uses pre-existing maps or generated maps to navigate the environment. While effective in structured environments and semi-structured environments, the map-based navigation has several limitations. In the unstructured environments, creating reliable maps can be impossible due to the dynamic and unpredictable nature of the associated terrain. Additionally, the map-based navigation can rely heavily on accurate localization, which may be compromised in the environments with poor Global Positioning System (GPS) signals and limited visual landmarks. As a result, map-based navigation systems struggle with real-time decision-making in the complex and anonymous terrains.

Another approach to the aforementioned problems may include using of rule-based navigation systems where the autonomous robot follows predefined rules and/or heuristics to navigate its surroundings. The predefined rules may include avoiding certain terrain features (like steep slopes) and following specific patterns of movement. While the rule-based systems handle certain scenarios effectively, the rule-based systems are inflexible and may not adapt well to new and unforeseen situations, such as causing the failure of successful navigation by the autonomous robot in environments that may not conform to the expected patterns, leading to suboptimal performance and even mission failure.

Further, various technical problems may plague conventional navigation systems and methodologies which lack flexibility in adapting to the dynamic and anonymous terrains. Conventional systems may react too late to hazardous conditions, for example by providing feedback only after encountering danger which may jeopardize operation of the autonomous robot. Additionally, using user feedback and/or control via human intervention to navigate unknown environments may reduce or entirely eliminate the autonomy, and further slowdown the performance of robotic tasks, making such systems impractical for time-sensitive and remote missions.

Therefore, there is a need for innovative approaches that address the aforementioned short-comings and disadvantages of conventional robotic navigation systems in unknown terrains and environments, by providing a flexible, real-time terrain classification able to adapt to adverse operational conditions and environments.

### SUMMARY

In one general aspect, the instant disclosure describes a system for real-time terrain classification via an autonomous robot. The system may include the autonomous robot including one or more sensors configured to sense one or more characteristics of a physical environment including a terrain; one or more processors; and one or more memories having stored thereon processor-executable instructions that, when executed by the one or more processors, cause the one or more processors to: obtain, via the one or more sensors, environmental data indicating the one or more characteristics of the physical environment of the autonomous robot sensed by the one or more sensors; classify, via the autonomous robot, at least a portion of the terrain of the physical environment based upon analyzing the environmental data, wherein classifying at least the portion of the terrain is performed substantially in real-time based upon evaluating the one or more characteristics of the physical environment indicated in the environmental data to determine whether at least the portion of the terrain is safe for the autonomous robot to successfully traverse; and based upon classifying at least the portion of the terrain with a first classification indicating no determination whether at least the portion of the terrain is safe for the autonomous robot to successfully traverse, cause the autonomous robot to: determine a terrain assessment task associated with classifying at least the portion of the terrain associated with the first classification; determine whether performing the terrain assessment task will exceed a performance threshold indicating an adverse effect on the autonomous robot performing a mission task; based upon determining performing the terrain assessment task will exceed the performance threshold, cause the autonomous robot to refrain from performing the terrain assessment task; and based upon determining performing the terrain assessment task will not exceed the performance threshold, cause the autonomous robot to: perform the terrain assessment task; based upon performing the terrain assessment task, reclassify at least the portion of the terrain as safe or unsafe for the autonomous robot to successfully traverse; and based upon reclassifying at least the portion of the terrain, cause the autonomous robot to perform the mission task.

In another general aspect, the instant disclosure describes a computer-implemented method for real-time terrain classification. The computer-implemented method may include obtaining, via one or more processors, environmental data indicating one or more characteristics sensed via one or more sensors of a physical environment including terrain of an autonomous robot; classifying, via the one or more processors, at least a portion of the terrain of the physical environment based upon analyzing the environmental data, wherein classifying at least the portion of the terrain is performed substantially in real-time based upon evaluating the one or more characteristics of the physical environment indicated in the environmental data to determine whether at least the portion of the terrain is safe for the autonomous robot to successfully traverse; and based upon classifying at least the portion of the terrain with a first classification indicating no determination whether at least the portion of the terrain is safe for the autonomous robot to successfully traverse: determining, via the one or more processors, a terrain assessment task associated with classifying at least the portion of the terrain associated with the first classification; determining, via the one or more processors, whether performing the terrain assessment task will exceed a performance threshold indicating an adverse effect on performing a mission task; based upon determining whether performing the terrain assessment task will exceed the performance threshold, generating, via the one or more processors, terrain assessment task configuration data for configuring the autonomous robot to either: refrain from performing the terrain assessment task; or perform the terrain assessment task; and transmitting, via the one or more processors, the terrain assessment task configuration data to the autonomous robot causing configuration of the autonomous robot associated with the terrain assessment task.

In another general aspect, the instant disclosure describes a non-transitory computer-readable medium storing processor-executable instructions that, when executed by one or more processors, may cause the one or more processors to at least: obtain environmental data indicating one or more characteristics of a physical environment including terrain of an autonomous robot; classify at least a portion of the terrain of the physical environment based upon analyzing the environmental data, wherein classifying at least the portion of the terrain is performed substantially in real-time based upon evaluating the one or more characteristics of the physical environment indicated in the environmental data to determine whether at least the portion of the terrain is safe for the autonomous robot to successfully traverse; and based upon classifying at least the portion of the terrain with a first classification indicating no determination whether at least the portion of the terrain is safe for the autonomous robot to successfully traverse: determine a terrain assessment task associated with classifying at least the portion of the terrain associated with the first classification; determine whether performing the terrain assessment task will exceed a performance threshold indicating an adverse effect on performing a mission task; based upon determining whether performing the terrain assessment task will exceed the performance threshold, generate terrain assessment task configuration data for configuring the autonomous robot to either: refrain from performing the terrain assessment task; or perform the terrain assessment task; and transmit the terrain assessment task configuration data to the autonomous robot causing configuration of the autonomous robot associated with the terrain assessment task.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a block diagram depicting an example computing environment for real-time terrain classification in one implementation of the instant application.

FIG. 1B is a block diagram depicting an example terrain classification subsystem of the system shown in FIG. 1A in one implementation of the instant application.

FIG. 1C is a block diagram depicting an example decision-making subsystem of the system shown in FIG. 1A in one implementation of the instant application.

FIG. 1D is a block diagram depicting an example task execution subsystem of the system shown in FIG. 1A in one implementation of the instant application.

FIG. 2 is a block diagram depicting an example training process of a machine learning model in one implementation of the instant application.

FIG. 3A is a block diagram depicting an example high-level workflow for real-time terrain classification in one implementation of the instant application.

FIG. 3B depicts an example environment for performing real-time terrain classification in one implementation of the instant application.

FIG. 3C depicts an example first user interface of a terrain classification application of the computing device in one implementation of the instant application.

FIG. 3D depicts an example second user interface of a terrain classification application of the computing device in one implementation of the instant application.

FIG. 4 flow diagram depicting an example computer-implemented method for real-time terrain classification in one implementation of the instant application.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

The disclosed systems and methods provide real-time terrain classification of an environment, such as real-time classification by an autonomous robot of terrain of its surrounding environment. An example system may include the autonomous robot including one or more sensors each configured to generate a respective set of senor data by sensing one or more characteristics of the physical environment and associated terrains. The sensors may detect the shape, slope, grade, altitude, weather, material composition, and/or other suitable characteristics of the environment. The system may obtain (e.g., via the sensors) environmental data that includes one or more sets of sensor data generated by one or more respective sensors. For example, the environmental data may include sensors datasets that each indicate temperature, altitude, wind speed, material competition, and a point cloud of the associated environment and its terrain. The system may analyze the environmental data to classify (e.g., via the autonomous robot) the terrain of the physical environment based upon its characteristics (e.g., material composition of the terrain, shape of the terrain, obstacles on the terrain, etc.). The system may perform the terrain classification in real-time to determine whether at least the portion of the terrain is safe for the autonomous robot to successfully traverse. The system may classify the terrain with a first classification indicating it could not be determined whether the terrain is safe for the autonomous robot to successfully traverse. For example, the system may generate the first classification based upon identifying unknown objects of the terrain in a point cloud of the environmental data. In response to the first classification, the system may determine a terrain assessment task associated with reclassifying the portion of the terrain as safe or unsafe for the autonomous robot to successfully traverse. For example, the terrain assessment task may include transmitting a request for new information to a computing device, such as new information indicating user feedback used to reclassify the terrain or user feedback that includes the reclassification itself. In another example, the terrain assessment task may include causing the autonomous robot to safely probe the portion of terrain (e.g., via its sensors) to further assess the ability of the autonomous robot to successfully traverse the portion of terrain.

The system may determine whether performing the terrain assessment task will exceed a performance threshold that indicates an adverse effect on the autonomous robot performing a mission task. The mission task may include one or more tasks for which the autonomous robot was placed in the environment, such as investigation of the environment, search and/or rescue, etc. The performance threshold may be associated with a delay in performing the mission task, a non-completion of the mission task, or resource usage of the autonomous robot. In one implementation, based upon determining that performing the terrain assessment task will exceed the performance threshold, the system may cause the autonomous robot to refrain from performing the terrain assessment task. In one implementation, based upon determining that performing the terrain assessment task will not exceed the performance threshold, the system may cause the autonomous robot to perform the terrain assessment task. In response to performing the terrain assessment task, the system may reclassify the portion of the terrain as safe or unsafe for the autonomous robot to successfully traverse, and based upon the reclassification of the portion of the terrain, cause the autonomous robot to perform the mission task.

The disclosed systems and methods address the aforementioned shortcomings of conventional terrain classification systems and technologies by providing real-time terrain classification able to adapt to adverse operational and/or environmental conditions. Rather than being unable to navigate environments where predefined mappings, limited location and/or landmark data is available, the disclosed techniques are able to generate environmental data of characteristics of unknown environments. Even when the environmental data does not provide enough information for classifying associated terrain, the disclosed systems and methods can implement one or more terrain assessment tasks to obtain additional information resulting in terrain classification, such as requesting feedback and/or probing terrain unknown to the robot. Performance of the terrain assessment task can mitigate or eliminate the inability of the robot to traverse terrain it is not previously trained to classify and/or the misclassification of hazardous terrain as safe, allowing the robot to adapt to and successfully operate in new and unforeseen environments. Moreover, based upon an initial first classification of a terrain as unknown, one or more terrain assessment tasks can be determined and performed in real-time before the successful completion of the mission task by the robot is compromised and/or the robot is confronted with a hazardous situation caused by the unknown terrain.

The disclosed system and methods improve the operation of the terrain classification system itself. In one example, the system evaluates whether to perform the terrain assessment task based upon a performance threshold associated with an adverse effect on performing the mission task if the robot performs the terrain assessment task. For example, if performing a terrain assessment task would cause the robot to run out of battery power during the mission task causing it to remain uncompleted and perhaps result in the loss of the unpowered robot which can no longer operate, performing the terrain assessment task could exceed the performance threshold. The performance threshold evaluation occurs before the terrain assessment task is performed, which can result in the conservation of computing resources (e.g., power, processing cycles, memory) that would otherwise be expended if the performance threshold evaluation did not take place. For example, if the robot performs the mission task resulting in a complete depletion of battery power during the mission task, the repowered robot (or a second robot if the original robot is irretrievable duc to power loss) may need to be redeployed to perform the otherwise uncompleted mission task, which may include re-performing mission tasks of the robot that lost power. In such a scenario, redeploying a (second) robot to finish the uncompleted mission task expends computing resources that would have otherwise been conserved if the performance threshold evaluation was performed. Accordingly, whereas existing terrain classification systems may react too late to avoid hazardous conditions or detrimental consequences to the robot associated with performing tasks, the disclosed system prevents such situations.

In another example, the disclosed techniques may provide improvement of terrain classifier of the disclosed system. The terrain classifier may be updated based upon information obtained from the terrain assessment task (e.g., user feedback, sensor data, etc.) and/or successful reclassification of an unknown terrain. The update may cause subsequent unencountered terrains which may have previously been unclassifiable before updating the classifier, to now be classifiable by the system, further improving real-time classification of unknown terrain as time goes on. Accordingly, the disclosed system may provide improve functionality compared to conventional systems where each environment's traversability may need to be defined before robotic deployment.

In yet another example, conventional prior art terrain classification systems may expend computing resources to request and receive human intervention whenever encountering unknown environments. The disclosed system may select an appropriate terrain assessment (e.g., autonomously) which may result in unknown terrain reclassification (e.g., via probing unknown terrain) rather than needing to stop its performance and await human intervention. Moreover, even if human feedback is required, the system is configured to request and receive such feedback in real-time, and the feedback can be provided by a user using natural language for comprehension by the robot, rather than requiring feedback necessitating more complex technical frameworks and knowledge (e.g., computer code). Further, the disclosed system may use the feedback to improve subsequent classifications such that human feedback would no longer be needed when encountering similar terrains. Accordingly, the disclosed techniques can require minimal technical knowledge by the user, to thereby simplifying and improving the technical field of terrain classification.

In sum, the disclosed system and methods provide improvements to the operation of terrain classification systems, and the technology/technical field of terrain classification, providing advancements in the field of art respective to conventional techniques which can require predefined maps of environment, misclassify terrain, be unadaptable to unknown environments, require regular human feedback and/or intervention preventing real-time terrain classification and/or robotic autonomy, among other things.

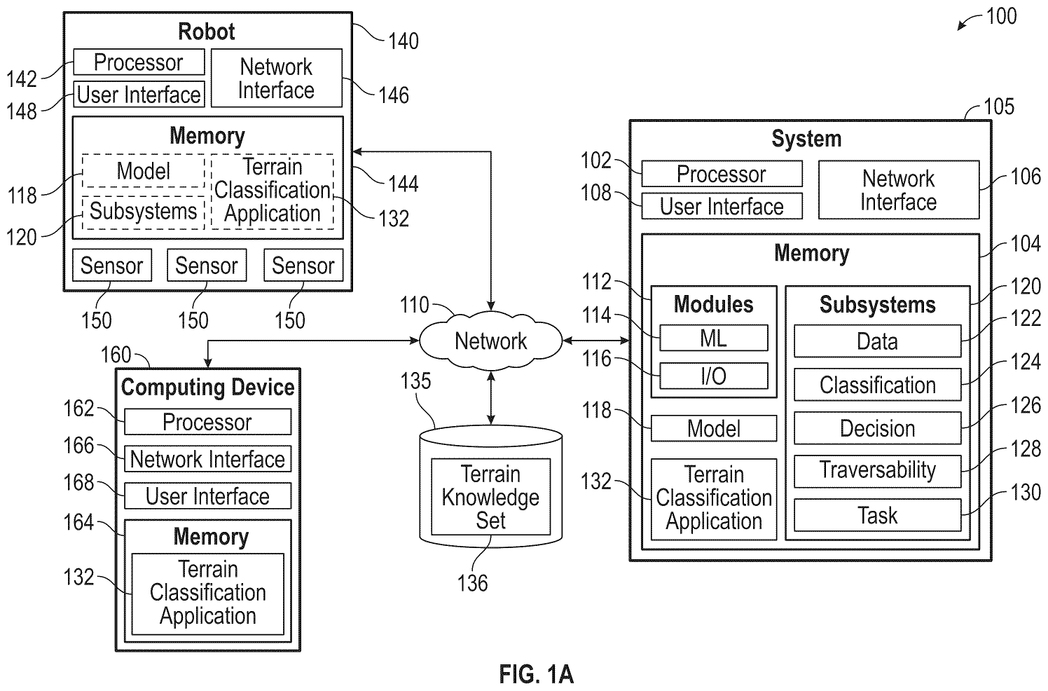

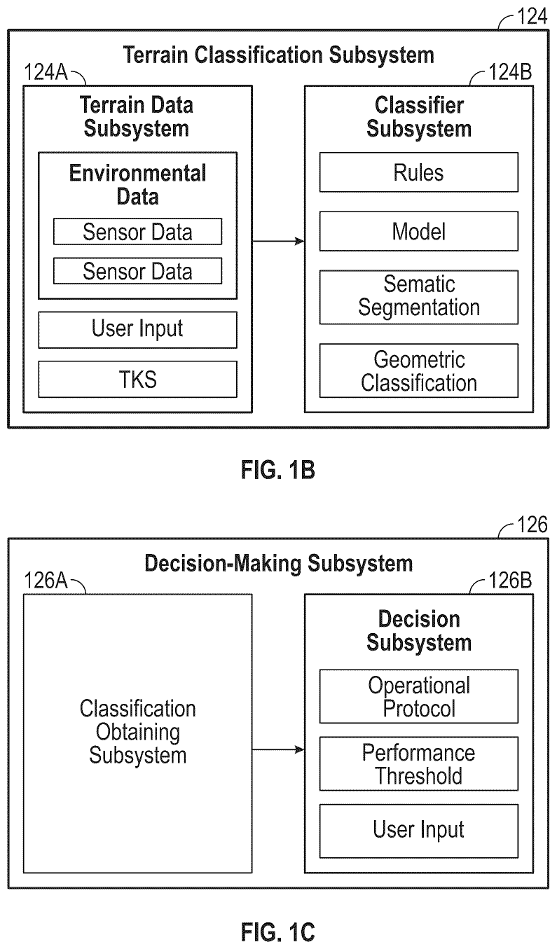

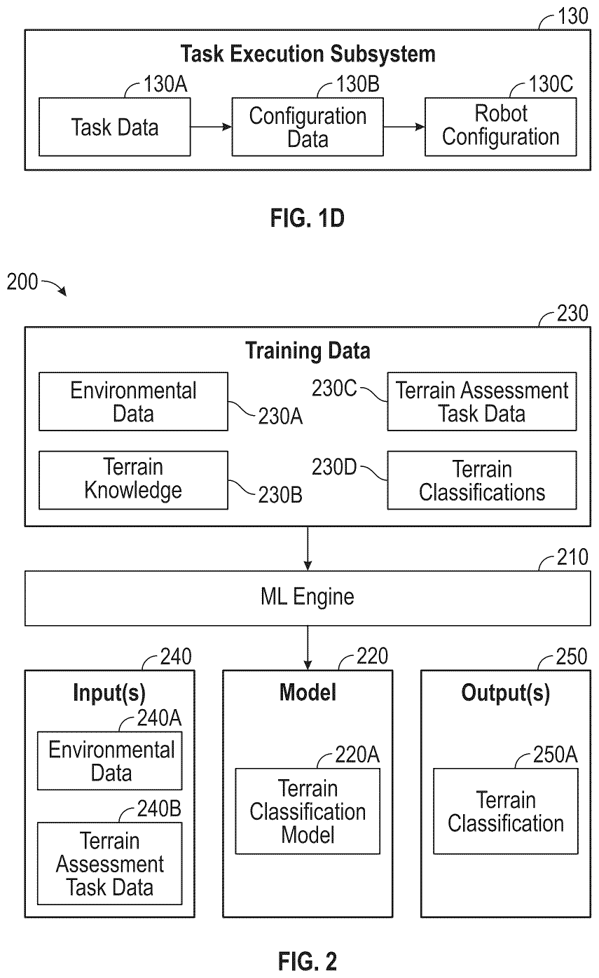

FIG. 1A is a block diagram depicting an example computing environment 100 for real-time terrain classification in one implementation of the instant application. The computing environment 100 may include a system 105 communicatively coupled, via a network 110, to a robot 140, a database 135, and a computing device 160. Although FIG. 1A depicts certain entities, components, equipment, and devices, it should be appreciated that fewer, additional and/or alternate entities, components, equipment, and/or devices may be envisioned.

The system 105 may perform functionalities associated with real-time terrain classification via an autonomous robot 140, such obtaining environmental data, classifying terrain, configuring the robot 140, training a model (e.g., a machine learning (ML) model), etc. The system 105 may include, and or be part of, a cloud network or may otherwise communicate with other hardware or software components within one or more cloud computing environments to send, retrieve, or otherwise analyze data or information described herein. For example, in certain aspects of the present techniques, the computing environment 100 may include an on-premise computing environment, a multi-cloud computing environment, a public cloud computing environment, a private cloud computing environment, and/or a hybrid cloud computing environment. For example, an entity (e.g., a robotics company) may host one or more services in a public cloud computing environment (e.g., Alibaba Cloud®, Amazon Web Services® (AWS), Google Cloud®, IBM Cloud®, Microsoft Azure®, etc.). The public cloud computing environment may be a traditional off-premise cloud (i.e., not physically hosted at a location owned/controlled by the entity). Alternatively, or in addition, aspects of the public cloud may be hosted on-premises at a location owned/controlled by the entity. The public cloud may be partitioned using visualization and multi-tenancy techniques and may include one or more infrastructure-as-a-service (IaaS) and/or platform-as-a-service (PaaS) services.

The system 105 may include at least one processor 102. The processor 102 may include one or more computational circuits, including, but not limited to, one or more central processing units (CPUs), microprocessor units, microcontrollers, complex instruction set computing (CISC) microprocessor units, reduced instruction set computing microprocessor (RISC) units, very long instruction word microprocessor units, explicitly parallel instruction computing microprocessor units, graphics processing units (GPUs), digital signal processing (DPS) units, or any other type of processing circuit. The processor 102 may also include embedded controllers, such as generic or programmable logic devices or arrays, application-specific integrated circuits (ASICs), single-chip computers, and the like. The processor 102 may be connected to a memory 104 via a computer bus (not depicted) responsible for transmitting electronic data, data packets, and/or otherwise electronic signals to and from the processor 102 and a memory 104 in order to implement or perform the machine-readable instructions, methods, processes, elements, or limitations, as illustrated, depicted, or described for the various flowcharts, illustrations, diagrams, figures, and/or other disclosure herein. The processor 102 may interface with the memory 104 via a computer bus to execute an operating system and/or computing instructions contained therein, and/or to access other services/aspects. For example, the processor 102 may interface with the memory 104 via the computer bus to create, read, update, delete, or otherwise access or interact with the data stored in the memory 104 and/or the database 135.

The system 105 may include at least one network interface 106. The network interface 106 may allow the system 105 to communicate over the network 110, for example via any suitable wired and/or wireless connection. The network interface 106 may include one or more hardware, firmware, and/or software components (e.g., Ethernet cards, Wi-Fi adapters, cellular modems). The network interface 106 may include one or more transceivers (e.g., wireless wide area network (WWAN), wireless local area network WLAN, and/or wireless personal area network (WPAN) transceivers) functioning in accordance with IEEE® standards, 3GPP® standards, and/or other standards, and that may be used in receipt and transmission of data (e.g., via external/network ports connected to the network 110).

The system may include at least one user interface 108. The user interface 108 may include one or more components and/or devices to receive an input and/or generate an output. The user interface 108 may include one or more of a keyboard, a mouse, a display (e.g., liquid crystal display (LCD), organic light-emitting diode (OLED) display), a touchscreen, a microphone, a speaker, an imaging device, a button, a switch, and/or other suitable components or device for to receiving an input and/or generating an output.

The memory 104 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), compact disks, digital video disks, diskettes, magnetic tape cartridges and/or other hard drives, flash memory, MicroSD® cards, and others. The memory 104 may store an operating system (e.g., Microsoft Windows®, Linux®, UNIX®, etc.) capable of facilitating the functionalities, apps, methods, or other software as discussed herein. In general, a computer program or computer based product, application, or code (e.g., ML models or other computing instructions described herein) may be stored on a machine-readable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 102 (e.g., working in connection with the respective operating system in memory 104) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang®, Python®, C®, C++®, C#®, Objective-C®, Java®, Scala®, ActionScript®, JavaScript®, HTML®, CSS®, XML®, etc.).

The memory 104 may store at least one computing module 112. The computing module 112 may be implemented as respective sets of computer-executable instructions (e.g., one or more source code libraries) as described herein. A component or device (standalone, client or distributed computer or computing system) configured by an application may constitute a computing module 112, also referred to herein at times interchangeably as a “subsystem” or “module,” that is configured and operated to perform certain operations. In one implementation, the computing module 112 may be implemented mechanically or electronically. The computing module 112 may include dedicated circuitry or logic that is permanently configured (within a special-purpose processor) to perform certain operations. In another implementation, the computing module 112 may also include programmable logic or circuitry (as encompassed within a general-purpose processor or other programmable processor) that is temporarily configured by software to perform certain operations. Accordingly, the term computing module 112 should be understood to encompass a tangible entity, be that an entity that is physically constructed permanently configured (hardwired) or temporarily configured (programmed) to operate in a certain manner and/or to perform certain operations described herein.

The computing module 112 may include an ML module 114. The ML module 114 may perform ML model training and/or operation. In at least some implementations, at least one of a plurality of ML methods and algorithms may be applied by the ML module 114, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various implementations, the implemented ML methods and algorithms are directed toward at least one of a plurality of categorizations of ML, such as supervised learning, unsupervised learning, and reinforcement learning. In one aspect, the ML based algorithms may be included as a library or package executed on the system 105. For example, libraries may include the TensorFlow® based library, the PyTorch® library, and/or the scikit-learn Python® library.

In one implementation, the ML module 114 employs supervised learning, which involves identifying patterns in existing data to make predictions about subsequently received data. Specifically, the ML module 114 is “trained” using training data, which includes exemplary inputs and associated exemplary outputs. Based upon the training data, the ML module 114 may generate a predictive function which maps outputs to inputs and may utilize the predictive function to generate ML outputs based upon data inputs. The exemplary inputs and exemplary outputs of the training data may include any of the data inputs or ML outputs described above. In the exemplary implementations, a processing element may be trained by providing it with a large sample of data with known characteristics or features.

In another implementation, the ML module 114 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 114 may organize unlabeled data according to a relationship determined by at least one ML method/algorithm employed by the ML module 114. Unorganized data may include any combination of data inputs and/or ML outputs as described above.

In yet another implementation, the ML module 114 may employ reinforcement learning, which involves optimizing outputs based upon feedback from a reward signal. Specifically, the ML module 114 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML module 114 may include a set of computer-executable instructions implementing ML training (e.g., model creation, fine-tuning, retraining, etc.). The ML module 114 may access one or more repositories (e.g., the database 135) or any other data source for training data suitable to generate and/or otherwise train one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into ML module 114 at runtime to process input data and generate output data.

The ML module 114 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The ML module 114 may include a set of computer-executable instructions implementing ML loading, configuration, initialization and/or operation functionality. The ML module 114 may include instructions for storing trained models (e.g., in the database 135). As discussed, once trained, the one or more trained ML models may be operated in inference mode, whereupon when provided with de novo input that the model has not previously been provided, the model may output one or more predictions, classifications, etc., as described herein.

While various implementations, examples, and/or aspects disclosed herein may include training and generating one or more ML models for the system 105 to load at runtime, it is also contemplated that one or more appropriately trained ML models may already exist (e.g., stored on the robot 140, in the database 135) such that the system 105 may load an existing trained ML model at runtime. It is further contemplated that the system 105 may retrain, fine-tune, update and/or otherwise alter an existing ML model before and/or after loading the model at runtime. Accordingly, one device (e.g., the system 105) of the computing environment 100 may train the ML model while another device (e.g., the robot 140) may execute the ML model.

The computing module 112 may include an input/output (I/O) module 116, including a set of computer-executable instructions implementing communication functions. The I/O module 116 may include a communication component configured to communicate (e.g., send and receive) data via one or more external/network port(s) to one or more components (e.g., the user interface 108), networks (e.g., the network 110) devices (e.g., the robot 140 and/or the computing device 160) as described herein. I/O module 116 may further include or implement an operator interface configured to present information to an administrator or operator and/or receive inputs from the administrator and/or operator (e.g., via the user interface 108). The I/O module 116 may facilitate I/O components (e.g., ports, capacitive or resistive touch sensitive input panels, keys, buttons, lights, LEDs), which may be directly accessible via, or attached to, the system 105 or may be indirectly accessible via or attached to another device (e.g., the computing device 160).

The memory 104 may include at least one model 118. The model may include a routine ML model, or other element stored in memory 104 may be referred to as receiving an input, producing or storing an output, or executing, the routine, model, or other element. The model 118 may be executing as instructions on the processor 102. Further, those of skill in the art will appreciate that the model 118 be stored in the memory 104 as executable instructions, which instructions the processor 102 may retrieve from the memory 104 and execute. Further, the processor 102 should be understood to retrieve from the memory 104 any data necessary to perform the executed instructions (e.g., data required as an input to model 118), and to store in the memory 104 the intermediate results and/or output of any executed instructions.

The memory 104 may include one or more subsystems 120. The subsystems 120 may include a data-obtaining subsystem 122, a terrain classification subsystem 124, a decision-making subsystem 126, a traversability update subsystem 128, and a task execution subsystem 130. In at least some implementations, a goal of the subsystems 120 may be to cause the robot 140 to operate exclusively in terrain classified as safe. For example, the subsystems 120 may cause unknown terrain to be avoided by the robot 140 until it is reclassified as safe, and entirely avoid terrain classified as unsafe. Conservative thresholds, adaptive risk policies, and/or statistical calibration may minimize false negatives associated with the classification of terrain as safe. User, offboard (e.g., remote from the robot 140), and/or proprioceptive feedback loops can permit controlled expansion of safe terrain without compromising the goal of causing the robot 140 to operate exclusively in safe terrain.

The data-obtaining subsystem 122 may be configured to obtain data, such as sensor data and/or environmental data, feedback data, and/or any other suitable data. The sensor data may be obtained from memory (e.g., the memory 104), from another component and/or device (e.g., from one or more sensors 150 of the robot 140 and/or the computing device 160 via the network 110), and/or any other suitable source of data. The data-obtaining subsystem 122 may provide continuous multimodal sensing via the one or more sensors 150 at high frequency.

The terrain classification subsystem 124 may be configured to analyze the one or more sensor datasets of the environmental data to classify the terrain into categories (e.g., safe, unsafe, traversable, untraversable, navigable, unnavigable, lethal, known, anonymous). The terrain classification subsystem 124 may allow the robot 140 to classify the terrain without increasing a false negative rate on a safe category. This is critical for ensuring that the robot 140 may continue to move safely and smoothly as the robot 140 encounters new types of the terrain. The terrain classification subsystem 124 may prevent the robot 140 from mistakenly identifying hazardous terrain as traversable, which is critical for minimizing an expected failure rate. The terrain classification subsystem 124 may be configured to handle the continuous evaluation and classification of the terrain (e.g., in real-time), causing the robot 140 to accurately identify a safety level or traversability of the terrain.

The decision-making subsystem 126 may be configured to evaluate the classified terrain and make decisions associated with operating the robot 140 (e.g., autonomously) based on operational protocol, performance thresholds of the robot 140, user input, and/or other suitable criteria. For instance, the decision-making subsystem 126 may determine whether the robot 140 should proceed, avoid, and/or further investigate (via performing a terrain assessment task) the terrain. If the terrain is unknown, the robot 140 may request input, such as input from a user of the computing device 160.

The traversability update subsystem 128 may be configured to update a terrain knowledge set (TKS) (e.g., TKS 136 stored in the database 135) based on new information associated with the terrains. If the robot 140 learns whether a terrain (e.g., unknown terrain) is traversable or non-traversable, the traversability update subsystem 128 may integrate such information into the TKS, which may improve future terrain classification. When the robot 140 receives feedback (e.g., from a user of the computing device 160), the traversability update subsystem 128 may process and incorporate the feedback into the system 105. The traversability update subsystem 128 may perform rule-based and learning-based methods to update the TKS, for example updating the TKS with geometric properties (e.g., slope, step height) with semantic safety labels for an associated terrain.

The task execution subsystem 130 may be configured to cause the robot to perform one or more tasks (e.g., tasks determined by the decision-making subsystem 126), for example by configuring the robot 140 with instructions, code, and/or otherwise configuration data. The task execution subsystem 130 may use the classified terrain to plan a safe and efficient route for the robot 140. The task execution subsystem 130 may avoid untraversable areas and/or optimize the navigation path to avoid unnecessary detours. The task execution subsystem 130 may execute a planned navigation path, adjust movements of the robot 140 in real-time based upon sensor data, and/or provide other performance associated with executing one or more tasks (e.g., a mission task and/or terrain assessment task). The task execution subsystem 130 may generate data that can configure the robot 140 to perform one or more tasks. For example, the decision-making subsystem 126 may generate terrain assessment task configuration data for configuring the robot 140 to perform a terrain assessment task associated with investigating unknown terrains. In another example, the decision-making subsystem 126 may generate mission task configuration data for configuring the robot 140 to perform a mission task. In yet another example, the decision-making subsystem 126 may generate navigation data for configuring the robot 140 to perform a navigation task by traveling along a navigation path. Upon receiving and processing the configuration data, the robot 140 may perform the associated task (e.g., the terrain assessment task, the mission task, or navigation).

The memory 104 may store a terrain classification application 132. The terrain classification application 132 may cause the system 105 to perform one or more functions associated with terrain classification (e.g., in real-time), such as obtaining and/or analyzing environmental data, classifying terrain, generating and/or updating terrain knowledge, configuring and/or communicating with the robot 140, and/or other suitable functions. Accordingly, the terrain classification application 132 may interact without components and/or devices of the computing environment 100, such as the model 118, the subsystems 120, the network 110, the robot 140, and/or the computing device 160.

The network 110 may generally enable bidirectional communication between devices and/or components of the computing environment 100, such as the system 105, the robot 140, the database 135, and/or the computing device 160. The network 110 may be, and/or include, one or more wired communication networks and/or a wireless communication networks. The wired communication network may include one or more Ethernet connections, Fiber Optics, Power Line Communications (PLCs), Serial Communications, Coaxial Cables, Quantum Communication, Advanced Fiber Optics, Hybrid Networks, and the like. The wireless communication network may include one or more of wireless fidelity (Wi-Fi), cellular networks (e.g., fourth generation (4G), fifth generation (5G), sixth generation (6G), Bluetooth®, ZigBee®, long-range wide area network (LoRaWAN), satellite communication, radio frequency identification (RFID), internet-of-things (IoT) networks, mesh networks, non-terrestrial networks (NTNs), near field communication (NFC), and the like. The network 110 may include any suitable network or networks, including a local area network (LAN), wide area network (WAN), Internet, and/or combination thereof. In one aspect, the network 110 may include a cellular base station, such as cellular tower(s), communicating to the one or more components of the computing environment 100 via wired/wireless communications based upon any one or more of various mobile phone standards, including Global System for Mobile Communications® (GSM), Code Division Multiple Access® (CDMA), Universal Mobile Telecommunications System® (UMTS), Long Term Evolution® (LTE), Ultra-wideband® (UWB), and/or the like. Additionally, or alternatively, the network 110 may include one or more routers, wireless switches, or other such wireless connection points communicating to the components of the computing environment 100 via wireless communications based upon any one or more of various wireless standards, including by non-limiting example, IEEE® 802.11 a/ac/ax/b/c/g/n (Wi-Fi), Bluetooth®, and/or the like.

The robot 140 may be configured to perform terrain classification (e.g., in real-time). The robot 140 may be, or include, one or more off a quadruped, a wheeled robot, a biped, a drone, an unmanned arial vehicle (UAV), or an unmanned terrestrial vehicle (UTV), and/or other suitable robot. The robot 140 may include a processor 142 (e.g., the processor 102) a memory 104 (e.g., the memory 104), a network interface 146 (e.g., the network interface 106), a user interface 148 (e.g., the user interface 108). The memory 144 may include the model 118, the subsystems 120, and/or the terrain classification application 132. The terrain classification application 132 of the robot 140 may include the same, or similar, functionality as the terrain classification application 132 of the system 105.

The robot 140 may include one or more sensors 150. The sensors 150 may include, but are not restricted to, one or more imaging sensors (e.g., camera, complementary metal-oxide-semiconductor (CMOS), light detection and ranging (LIDAR), radio detection and ranging (RADAR), infrared (IR)), chemical sensors (e.g., oxygen, carbon dioxide), pressure sensors, navigation sensors (e.g., global position system (GPS), inertial measurement unit (IMU)), proprioceptive sensors, environmental sensors (e.g., humidity, temperature, wind, ultra-violet (UV)), and/or any other suitable sensor. The one or more sensors 150 may capture sensor data, referred to at times herein as “environmental data,” that may indicate and/or is otherwise associated with one or more characteristics of the physical environment (e.g., terrain) of the sensor 150 and/or the robot 140. In one example, the one or more sensors 150 may include a camera configured to capture sensor data including images and/or video of the environment, and a LIDAR sensor configured to capture sensor data including a point cloud of the environment. The environmental data may include the images and/or video of the sensor data of the camera and the point cloud of the LIDAR sensor data. Each type of sensor data may provide information about a texture, a shape, size, composition, weather, and/or obstacles of the terrains of the environmental data. The sensors 150 may include a proprioceptive sensor configured to capture sensor data associated with monitoring an internal state of the robot 140 such as wheel slippage, joint angles, and force exerted on the terrain. The environmental data may include the proprioceptive sensor data and therefore indicate (e.g., directly and/or indirectly) characteristics of the terrains (e.g., loose soil, hard concrete, wet environment) and/or assist in assessing the terrain's interaction with the robot 140. The sensors 150 may include an environmental sensor configured to capture sensor data of the environmental data indicating environmental conditions such as temperature, humidity, wind speed and/or air pressure of the environment, which may indicate terrain safety. For example, a robot 140 that is a drone may only be able to traverse terrain that includes air if the wind speed of the air is below a certain speed.

The robot 140 may be configured to operate (e.g., navigate, perform tasks) autonomously without intervention (e.g., input, feedback, control, etc., from another device and/or user), semiautonomous with at least some intervention, and/or anything therebetween. For example, in implementations where the robot 140 may operate autonomously, the robot 140 may execute the terrain classification application 132 to perform terrain classification, including executing one or more of the model 118 and/or the subsystems 120 of the memory 144. In another example where the robot 140 may operate semiautonomously, the robot 140 may execute the terrain classification application 132 to perform terrain classification that includes receiving feedback, input, and/or otherwise data from a user (e.g., via the user interface 148, from a remote user of the computing device 160), from the system 105 (e.g., terrain classification preformed at the system 105), such that the robot 140 may not execute and/or the memory 144 may not include, one or more of the) one or more of the model 118, the subsystems 120, and/or the terrain classification application 132, as indicated by the associated dashed lines of FIG. 1A.

The computing environment 100 may include, and/or have access to (e.g., via the network 110) the database 135. The database 135 may be a relational database, such as Oracle®, DB2®, MySQL®, a NoSQL® based database, such as MongoDB®, or another suitable database. The database 135 may store data and/or datasets include one or more types of data, records, files, etc., however, the terms “data” and “dataset” may be used interchangeably herein. In at least some implementations, the database 135 may store and/or manage data related to the robotic deployment and the terrain classification, such as storing relevant data, enabling efficient data retrieval, and enabling analysis to support decision-making processes associated with real-time terrain classification. For example, the database 135 may be configured to store the TKS 136 indicating and/or otherwise associated with known terrain types and their classifications. However, it should be understood the TKS 136 may be stored in one or more other suitable storage components (e.g., one or more of the memories 104, 144, 164). One or more components and/or devices of the computing environment 100 (e.g., the system 105, robot 140, the computing device 160) may access the TKS 136 for reference during the terrain classification. The database 135 may facilitate optimizing the real-time terrain classification for the robotic deployment in the adverse operational conditions, ensuring that the system 105 operates at peak efficiency. The database 135 may manage user access controls, configuration settings, and system logs, providing a comprehensive solution for data management and a security within the computing environment 100.

The computing environment 100 may include at least one computing device 160. The computing device 160 may include one or more user devices, mobile devices, smartphones, Personal Digital Assistants (PDAs), tablet computers, phablet computers, wearable computing devices, virtual reality (VR) devices, augmented reality (AR) devices, laptops, desktops, display interface panels, control panels, human machine interface panels, liquid crystal display (LCD) screens, light-emitting diode (LED) screens, and the like. The computing device 160 may include a processor 162 (e.g., the processor 102, 142) a memory 164 (e.g., the memory 104, 144), a network interface 166 (e.g., the network interface 106, 146), a user interface 168 (e.g., the user interface 108, 148).

The memory 164 may include the terrain classification application 132 including the same, or similar, functionality as the terrain classification application 132 of the system 105 and/or robot 140. In at least some implementations, the terrain classification application 132 may allow a user of the computing device 160 to provide input associated with terrain classification which is received by the system 105 and/or the robot 140 via each device's respective terrain classification application 132. For example, the user may provide verbal (e.g., spoken) or typed (e.g., text) natural language feedback associated with terrain classification via the user interface 168, which is transmitted via the network 110 to the system 105 and/or the robot 140.

FIG. 1B is a block diagram depicting an example terrain classification subsystem 124 of the system 105 shown in FIG. 1A in one implementation of the instant application. The terrain classification subsystem 124 may include a terrain data subsystem 124A (e.g., implemented via the data-obtaining subsystem 122) configured to obtain one or more types of data associated with classifying terrain, such as the environmental data including sensor datasets, user input (e.g., from the user of the computing device 160) associated with feedback for classifying terrain, TKS (e.g., the TKS 136) indicating terrain knowledge, and/or other suitable data. The terrain classification subsystem 124 may include a classifier subsystem 124B that generates a classification of terrain based upon the associated data obtained by the terrain data subsystem 124A. The classifier subsystem 124B may generate the classification using one or more rules, models (e.g, the model 118), sematic segmentation, geometric classification, and/or other suitable methods of classification. For example, the classifier subsystem 124B may classify a terrain as safe based upon analyzing a point cloud using a three-dimensional semantic segmentation model. In at least some implementations, the classifier subsystem 124B may fuse various types of sensor data included in the environmental data to generate a voxel-based, probabilistic representation of the environment and/or its terrain, which may include one or more of noise removal (e.g., sensor noise), inpainting (e.g., obscured features of the environment), and/or prediction of terrain attributes (e.g., porosity, height, overhang, etc.). Classifying the terrain may include applying uncertainty quantification techniques (e.g., ensembles, Bayesian dropout) to characterize the reliability of the sensor data. The classification of a terrain may generate one or more associated classification metrics (e.g., a confidence metric) indicating the accuracy and/or uncertainty of the classification. In at least some implementations, classifying a terrain (e.g., previously unencountered terrain) may include generating one or more associated classification metrics which either exceed or do not exceed a terrain classification threshold. Based on assessing whether the terrain classification threshold is exceeded or not, the terrain may then be classified as unknown rather than safe. For example, if a terrain is initially classified as safe with a confidence metric of 65% confidence and the terrain classification threshold is 80%, the terrain classification subsystem 124 may cause the terrain to be reclassified as unsafe because the confidence metric of 65% does not exceed the 80% threshold. Such thresholds can ensure that the terrain which may be potentially unsafe is not classified as safe, thereby avoiding the increase of a false negative rate of the terrain classification subsystem 124 associated with misclassifying unsafe terrain as safe. Moreover, thresholds associated with terrain classification can ensure that safe regions define the complete operating envelope of the robot 140 during navigation of the environment.

FIG. 1C is a block diagram depicting an example decision-making subsystem 126 of the system shown in FIG. 1A in one implementation of the instant application. The decision-making subsystem 126 may include a classification obtaining subsystem 126A configured to obtain (e.g., from the terrain classification subsystem 124, the database 135) a classification associated with a terrain. The decision-making subsystem 126 may include a decision subsystem 126B configured to generate a decision for the robot 140 based upon the classified terrain. The decision subsystem 126B may generate the decision associated with the robot 140 based operational protocol, performance thresholds of the robot 140, user input (e.g., from a user of the computing device 160), and/or other suitable criteria. The decision subsystem 125B may operate hierarchically, for example a global planner component of the decision subsystem 125B may generate task-level goals (e.g., a goal of the terrain assessment task and/or mission task), and a local planner component of the decision subsystem 125B may may expand navigation paths on safe terrains. In one example, if the robot 140 is confined in narrow passages or near obstacles, the decision subsystem 125B may generate data causing the robot 140 to guarded motions at low speeds with proprioceptive monitoring to avoid damage to the robot 140. In another example, the decision subsystem 126B may determine whether the robot 140 should perform a terrain assessment task based upon whether its performance would exceed performance thresholds associated with computing resources expended while performing the terrain assessment task.

FIG. 1D is a block diagram depicting an example task execution subsystem 130 of the system shown in FIG. 1A in one implementation of the instant application. The task execution subsystem 130 may include a task data subsystem 130A (e.g., implemented via the data-obtaining subsystem 122) configured to obtain one or more types of information associated with a task, such as the details of a terrain assessment task determined by the decision-making subsystem 126. The task execution subsystem 130 may include a configuration data subsystem 130B configured to generate configuration data that can configure the robot 140 to perform the task. For example, the configuration data subsystem 130B may generate terrain assessment task configuration data that can configure the robot 140 to perform the terrain assessment task. The task execution subsystem 130 may include a robot configuration subsystem 130C that can perform configuration of the robot, for example by causing the robot 140 to process the configuration data generated by the configuration data subsystem 130B.

be configured to cause the robot to perform one or more tasks (e.g., tasks determined by the decision-making subsystem 126), for example by configuring the robot 140 with instructions, code, and/or otherwise configuration data. The task execution subsystem 130 may use the classified terrain to plan a safe and efficient route for the robot 140. The task execution subsystem 130 may avoid untraversable areas and/or optimize the navigation path to avoid unnecessary detours. The task execution subsystem 130 may execute a planned navigation path, adjust movements of the robot 140 in real-time based upon sensor data, and/or provide other performance associated with executing one or more tasks (e.g., a mission task and/or terrain assessment task). The task execution subsystem 130 may generate data that can configure the robot 140 to perform one or more tasks. For example, the decision-making subsystem 126 may generate terrain assessment task configuration data for configuring the robot 140 to perform a terrain assessment task associated with investigating unknown terrains. In another example, the decision-making subsystem 126 may generate mission task configuration data for configuring the robot 140 to perform a mission task. In yet another example, the decision-making subsystem 126 may generate navigation data for configuring the robot 140 to perform a navigation task by traveling along a navigation path. Upon receiving and processing the configuration data, the robot 140 may perform the associated task (e.g., the terrain assessment task, the mission task, or navigation).

The computing environment 100 may include additional, fewer, and/or alternate components, and may be configured to perform additional, fewer, or alternate actions, including components/actions described herein. Although the computing environment 100 is shown in FIG. 1A as including one instance of various components such as the system 105, the robot 140, the database 135, and the computing device 160, various aspects include the computing environment 100 implementing any suitable number of any of the components shown in FIG. 1A and/or omitting any suitable ones of the components shown in FIG. 1A. For example, the TKS 136 described as being stored in the database 135 may be stored in the memory 104 of the system 105 and/or the memory 144 of the robot 140, and therefore the database 135 may be omitted. Moreover, various aspects include the computing environment 100 including any suitable additional component(s) not shown in FIG. 1A, such as but not limited to the exemplary components described above. Furthermore, it should be appreciated that additional and/or alternative connections between components shown in FIG. 1A may be implemented. As just one example, system 105 and the database 135 may be connected via a direct communication link (not shown in FIG. 1A) instead of, or in addition to, via the network 110.

FIG. 2 is a block diagram 200 depicting an example training process of a machine learning model (e.g., the model 118) in one implementation of the instant application. Generally, a machine learning (ML) engine 210 (e.g., the ML module 114) trains a model 220 using training data 230. The ML engine 210 may train the ML model 220 via regression, k-nearest neighbor, support vector regression, and/or random forest algorithms and/or models, although any type of applicable ML algorithm and/or model may be used. Model training may be performed via one or more of supervised learning, unsupervised learning, semi-supervised learning, and/or reinforcement learning. Once trained, the ML model 220 may perform operations on one or more data inputs 240 to produce a desired data output 250.

The model 220 may include a terrain classification model 220A. The terrain classification model 220A may receive as input 240 one or more of environmental data 240A or terrain assessment task data 240B. The environmental data 240A may include data generated by one or more sensors (e.g., the one or more sensors 150) that indicate characteristics of the environment including the terrain to be classified. The environmental data 240A may indicate the slope, grade, altitude, weather, material composition, and/or other suitable characteristics of the environment and its terrain. The terrain assessment task data 240B may indicate information obtained from performing one or more terrain assessment tasks, such as information associated with classifying at least the portion of the terrain based upon a request for such information. For example, based upon encountering unknown terrain, the robot 140 may perform a terrain assessment task that includes requesting new information (e.g., from a user, from another computing device) associated with classifying the terrain. The terrain assessment task data 240B may include the new information that indicate characteristics of the terrain otherwise unknown from the environmental data 240A. In another example, the terrain assessment task data 240B may include information gathered when the robot 140 probes unknown terrain as part of a terrain assessment task.

To train the terrain classification model 220A, the engine 210 may use training data 230. The training data 230 may include historical environmental data 230A of historical terrains, historical terrain knowledge (e.g., the TKS 136) 230B of historical terrains, historical terrain assessment task data 230C of historical terrains, historical terrain classifications 230D of historical terrains, and/or any other suitable data for training the terrain classification model 220A. The engine 210 may be configured to process the training data 230 to learn associations and relationships in the training data 230, e.g., relationships indicating characteristics of historical terrains causing the historical terrains to be assigned a particular historical classification. The engine 210 may train the terrain classification model 220A based upon the learned association and relationship causing the trained terrain classification model 220A to be able to successfully classify 250A a new, unknow terrain as the output 250 based upon receiving environmental data 240A and/or terrain assessment task data 240B as the input 240. For example, the engine 210 may train the terrain classification model 220A to identify terrain having a slope greater than forty-five degrees as being associated with a classification 250A of unsafe for a terrestrial robot.

The engine 210 may retrain the model 220 using updated training data 230, for example to improve operation of the model 220, cause the model 220 to have additional capabilities, etc. For example, the robot may receive new terrain assessment task data 240B based upon being unable to classify a terrain via the engine 210. The new terrain assessment task data 240B may be stored as updated training data 230, such that when the terrain classification model 220A is retained using the new terrain assessment task data 240B, the retrained model is able to successfully generate a terrain classification 250A for terrain which the model would otherwise be unable to classify 250A previous to retraining.

It should be understood that functionality attributed to a single model 220 may be performed by two or more models. For example, the terrain classification model 220A may include a first model that analyzes the environmental data 240A such as a point cloud to extract features of the associated terrain, and a second model that receives the extracted features to generate the classification 250A of the terrain. Moreover, while model training and execute may be described as performed on the same device (e.g., the system 105), it should be understood that one device may train the model (e.g., the system 105) and another device may execute the trained model (e.g., the robot 140, the computing device 160), such that the model 220 may not be trained and executed by the same device.

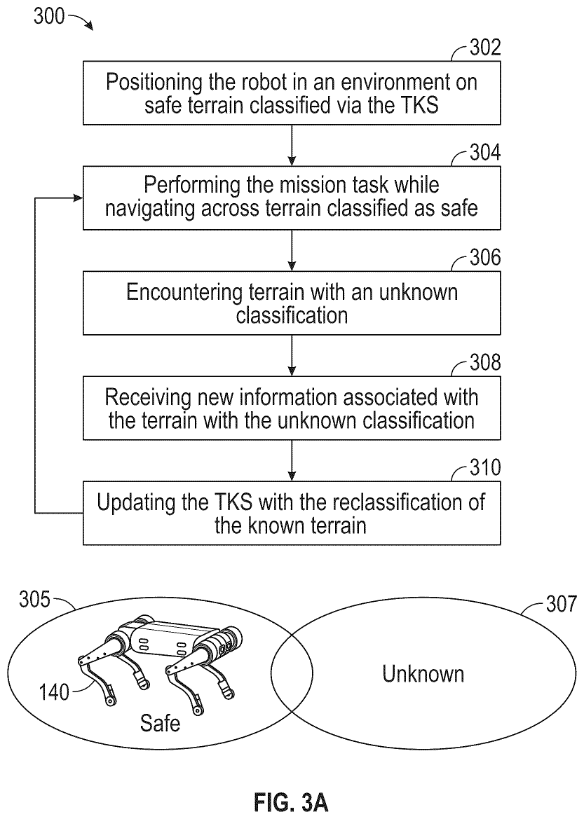

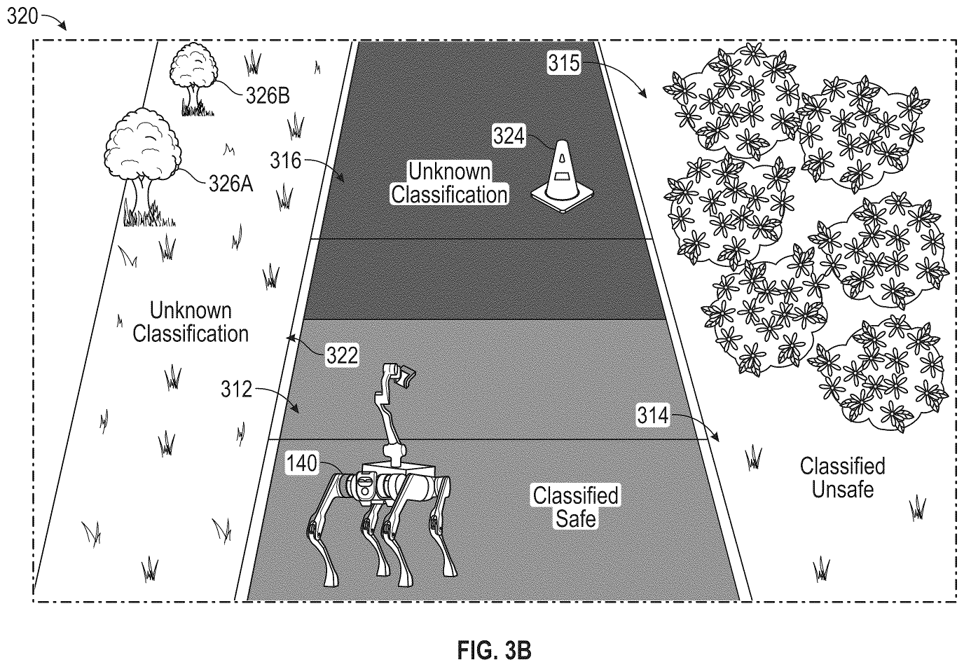

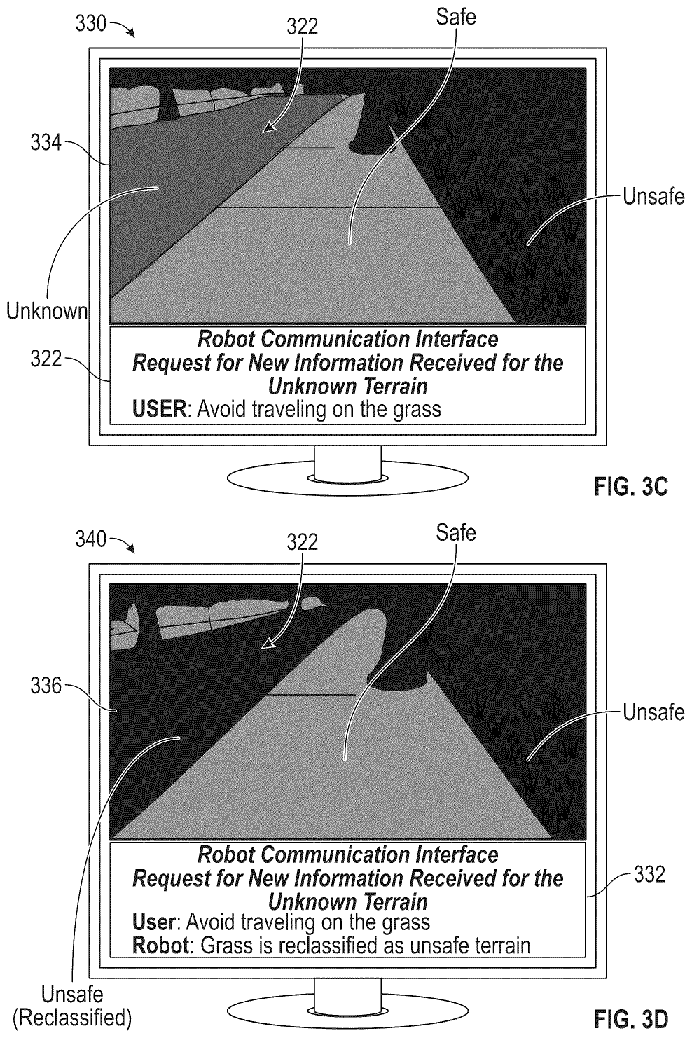

FIG. 3A is a block diagram depicting an exemplary workflow 300 for terrain classification in one implementation of the instant application. One or more steps, functions, processes, etc., of the workflow 300 may be performed via the computing environment 100 (e.g., the system 105, the robot 140, the computing device 160).

The exemplary workflow 300 may begin at block 302 by positioning the robot 140 in an environment on safe terrain 305 classified via the terrain knowledge set 136. The TKS 136 may indicate a classification associated with the safe terrain 305 being “safe” for the robot 140, such as terrain that is not dangerous and/or does not pose a risk to the robot 140 when performing one or more tasks for which the robot 140 is positioned in the environment, referred to herein at times as a “mission task.” For example, the terrain classification application 132 may store, configure, and/or otherwise provide the robot 140 with the mission task to be performed in the environment. In at least some implementations, the robot 140 may be configured to only travel across terrain 305 classified as safe, which indicates the robot 140 can traverse or otherwise travel on, over, and/or through the terrain 305 successfully (e.g., without getting stuck, damaged, tipping over) and/or without incident. In such an example, the TKS 136 may include data indicating the safe terrain 305 can support the weight of the robot 140, does not include obstacles the robot 140 is unable to maneuver around and/or over, is of a composition that would not cause a risk of the robot's wheels slipping (e.g., due to unstable terrain) and/or getting stuck (e.g., terrain that includes wet mud), etc., and/or is classified as safe for one or more suitable reasons. Accordingly, the TKS 136 may indicate a safe place in an environment to initially position the robot 140 before it begins its mission task, which may be crucial when other portions of terrain of the environment are unknown.

At block 304, the workflow 300 may include the robot 140 performing the mission task while navigating across terrain classified as safe. The TKS 136 may include limited knowledge of the environment of the robot 140, causing the robot 140 to evaluate terrain of the environment. The robot 140 may evaluate the terrain based upon generating environmental data via the one or more sensors 150. For example, each sensor 150 may sense the environment to generate a respective set of sensor data, and the environmental data may include each respective set of sensor data. The environmental data may indicate one or more characteristics of the environment and associated terrains, such as temperature, humidity, slope, grade, altitude, weather, material composition, and/or other suitable characteristics of the environment and terrain sensed by the sensors 150. In at least some implementations, the robot 140 may collect the environmental data while traversing terrain classified as safe and avoiding traversing terrain classified as unsafe. For example, the robot 140 may collect the environmental data when traveling autonomously along a navigation path across terrain indicated as safe via the TKS 136 or otherwise classifier (e.g., via the terrain classification application 132) to gather sensor data from unknown (e.g., unencountered) terrain. In at least some implementations, the robot 140 may collect the environmental data while stationary, for example when the sensors 150 (e.g., cameras, LIDAR sensors) are able to collect sensor data of unknown terrain beyond the safe terrain 305 in which the robot 140 is located.

As an example, the mission task may include the robot 140 traversing an unknown environment (e.g., with the exception of the safe terrain 305) such as a disaster area to locate people who may be in need of help, locate lost animals, evaluate real-time conditions, detect gas leaks, etc. Once the robot 140 is placed in the safe terrain 305, the robot 140 may cause (e.g., via the terrain classification application 132, the data-obtaining subsystem 122, based upon the configuration of the robot, etc.) the one or more sensors 150 to begin collecting environmental data associated with the environment of the robot 140. For example, the terrain classification application 132 may cause the data-obtaining subsystem 122 to transmit a signal to the robot 140 (e.g., locally on the robot 140 via a system bus, from the system 105 to the robot 140 via the network 110) causing sensor data to be gathered. This may include a camera being activated to begin collecting video data and image data of the environment and a LIDAR sensor being activated to begin generating a point cloud data modelling the environment to generate the environmental data. The robot 140 may collect the environmental data while stationary in the safe terrain 305, or while traversing a navigation path including safe terrain 305.

The terrain classification subsystem 124 may classify the terrain of the environment based upon the environmental data. For example, a plurality of sensors 150 of the robot 140 may generate respective sets of data (e.g., image data, video data, point cloud data, temperature data, humidity data, wind speed data, etc.) that each indicate one or more characteristics of an environment including the terrain, and the environmental data may include each of the sensor datasets. The terrain classification subsystem 124 may classify the terrain of the environment based upon the characteristics of the terrain indicated in the environmental data. In at least some implementations, the terrain classification subsystem 124 may perform a classification of the terrain of the environment in real-time (e.g., via the subsystems 120 local to the robot 140 and/or remotely via the subsystems 120 of the system 105). For example, the terrain classification application 132 may cause the environmental data to be provided to the terrain classification subsystem 124 locally on the robot 140 and/or remotely to the terrain classification subsystem 124 of the system 105 via the network 110.

The terrain classification subsystem 124 may classify the terrain via one or more of semantic segmentation, (e.g., two-dimensional, three-dimensional), rules, geometric classification, models 118, 220 (e.g., vision models, bird's-eye-view (BEV) models, TerrainNet), and/or any other suitable means, methods, and/or processes for classifying terrain. Classifying the terrain may include applying one or more classifications to the respective terrain associated with the safety of the terrain to the robot 140 (e.g., safety when performing the mission task, safety when traveling across the terrain, etc.). The types of classifications to apply to the terrain may be predefined (e.g., via the terrain classification subsystem 124, via the terrain classification application 132, etc.). In at least some implementations, the available classifications for applying to the terrain may be selected from a group of classifications that includes: a “safe” classification indicating the associated terrain is safe for the robot to successfully traverse or otherwise travel upon; an “unsafe” classification indicating the associated terrain is unsafe for the robot to successfully traverse or otherwise travel upon; or an “unknown” classification indicating it is unknown whether the associated terrain is unsafe for the robot to successfully traverse or otherwise travel upon. Based upon classifying the terrain, the traversability update subsystem 128 may update the TKS 136 (e.g., stored in the memory 104, the database 135, the memory 144) with information associated with classifying the terrain, such as information that includes the classification, the sensor and/or environmental data associated with the classified terrain, etc. For example, once the terrain is classified, the terrain classification application 132 may generate a signal causing the traversability update subsystem 128 to update the TKS 136 with information associated with the classified terrain. In at least some implementations, the updated information may be used to retrain the model 118 to improve subsequent classifications of terrains.

At block 304, the workflow 300 may include the robot 140 encountering unknown terrain 307 having an unknown classification, which may indicate there is no determination whether at least the portion of the associated terrain is safe and/or poses a low risk for the autonomous robot to successfully traverse. The unknown classification may be based upon a lack of information (e.g., no information stored in the TKS 136) associated with the terrain because it has yet to be encountered, and/or due to a previously determined unknown classification (e.g., indicated in the TKS 136, generated via the terrain classification subsystem 124) associated with the terrain.

FIG. 3B depicts an example environment 320 for performing real-time terrain classification in one implementation of the instant application. The environment 320 may include a first portion of terrain 312 classified as a safe. For example, and with simultaneous reference to FIGS. 3A and 3B, the first portion of terrain 312 may correspond to the safe terrain 305 in which the robot is initially placed within the environment 320.

The environment 320 may include a second portion of terrain 314 classified as unsafe. For example, while being positioned in the first portion terrain 312, the robot 140 may scan the second portion of terrain 314 using the one or more sensors 150 and generate an associated second environmental dataset indicting the location of the second portion of terrain 314 (e.g., via GPS sensors), that the terrain 314 includes shrubbery 315 (e.g., based upon a point-cloud of the second portion of terrain 314) that the robot 140 may not be able to successfully travel around and/or across. Further, the robot 140 may not be able to sense what is beyond the shrubbery 315. Based upon analyzing the second environmental dataset indicating these characteristics of the second portion of terrain 314, the terrain classification subsystem 124 may cause the second portion of terrain 314 to be classified as unsafe. The traversability update subsystem 128 may store (e.g., via the terrain classification application 132) information associated with the unsafe classification of the second portion of terrain 314 (e.g., the second environmental dataset, the associated classification) in the TKS 136. Based upon the unsafe classification of the second portion of terrain 314, the task execution subsystem 130 generate a navigation route, and/or update an existing navigation route, for the robot 140 which does not include the second portion of terrain 314, causing the robot 140 to avoid the second portion of terrain 314 as it traverses the environment to perform the mission task as indicated by block 304 of the workflow.

Block 306 of the workflow 300 of FIG. 3A may include the robot 140 encountering terrain with an unknown classification, such as the unknown terrain 307. As the robot 140 explores the environment (e.g., during performance of its mission task), the robot 140 may encounter terrain not included in the TKS 136. The robot 140 may determine the terrain is not in the TKS 136 using out-of-distribution detection methods (e.g., via one or more models 118 implemented by the terrain classification subsystem 124) such as feature-space distance, density modeling, or ensemble variance, which may result in a classification of the encountered terrain as unknown. One or more thresholds associated with classifying the terrain (e.g., the aforementioned terrain classification threshold) may be adapted, for example based upon the robot 140 (e.g., type of robot, its capabilities, etc.), the mission task, the environmental conditions, a risk tolerance, and/or other suitable criteria. Upon encountering terrain with an unknown classification (block 306), the terrain classification application 132 and/or other suitable component (e.g., via the decision-making subsystem 126, the traversability update subsystem 128) may cause the robot 140 and/or the system 105 to store (e.g., in the database 135) one or more of the associated sensor and/or environmental data of the terrain (e.g., proprioceptive sensor data indicating the pose of the robot), data associated with classifying the terrain as unknown (e.g., classifier metadata), and/or other suitable data associated with the unknown terrain, for example for review via user of the computing device 160. Adaptive, risk-aware out-of-distribution thresholds combined with comprehensive data logging can ensure that unknown terrain is treated conservatively respective to the operation of the robot 140 (e.g., the robot 140 is risk averse when performing tasks associated with the unknown terrain).

With reference now to FIG. 3B, the environment 320 may further include a third portion of terrain 316 and a fourth portion of terrain 322 of the environment 320 which are both classified as unknown. The robot may be traversing along a navigation path across the first portion of terrain 312 classified as safe to traverse when the robot 140 encounters the third portion of terrain 316 and fourth portion of terrain 322. Based upon encountering terrain classified as unknown, the decision-making subsystem 126 or other suitable components (e.g., the terrain classification application 132) may evaluate the unknown terrain by causing the robot 140 to perform one or more terrain assessment tasks. The terrain assessment task may be associated with determining whether the robot 140 should travel across the unknown terrain, avoid the unknown terrain, and/or further investigate the unknown terrain. The terrain assessment task may include one or more of: storing the sensor data and/or environmental data associated with the unknown terrain (e.g., in the TKS 136); causing the robot 140 to avoid traversing unknown terrain (e.g., via a navigation route generated via the task execution subsystem 130); requesting user input (e.g., from a user of the computing device 160) associated with the safety or otherwise classification of the unknown terrain; storing the user input the human's response; probing the terrain (e.g., via the robot 140) while keeping the robot 140 safe; and/or transmitting data associated with the unknown terrain (e.g., the associated sensor and/or environmental data, the user input) to a component (e.g., a more powerful model stored on the robot 140) and/or device (e.g. a remote device such as the system 105 having different and/or improved classification capabilities) to determine the safety and/or otherwise classification of the unknown terrain. The one or more terrain assessment tasks to perform may be determined based upon the configuration of the robot (e.g., the type of robot, the type of sensors available to perform the terrain assessment tasks, the operational state of the robot, the impact on performing the mission task), the computing devices (e.g., capabilities of the computing device such as the available computing resources, whether a user is available at the computing device), and/or any other suitable criteria. The integration of additional information received from performing one or more terrain assessment tasks associated with unknown terrain may allow the integration of multiple feedback channels and/or types of feedback to provide a conservative but flexible mechanisms to resolve terrain uncertainty.

In at least some implementations, upon encountering unknown terrain, the robot 140 (e.g., via the decision-making subsystem 126, the terrain classification application 132) may generate a request for new information associated with reclassifying the unknown terrain as either safe or unsafe. The request may include a sensor data and/or the environmental dataset generated by the one or more sensors 150 of the robot 140 and associated with the unknown terrain, and/or other suitable data and/or information. The robot 140 may transmit (e.g., via the network 110) the request to a computing device (e.g., the system 105, the computing device 160). A user of the computing device may provide input associated with classifying the unknown terrain. For example, the user may provide one or more user interfaces (e.g., the user interface 168) one or more labels for classifying the terrain, a command associated with classifying the terrain through (e.g., a natural language command), and/or other suitable feedback. Vision-language embeddings and/or promptable segmentation methods may support classification of the terrain based upon the user feedback. In response to the request for new information, the computing device may generate the new information associated with reclassifying the unknown terrain, such as new information received by the robot 140 and used to reclassify the unknown terrain (e.g., at the robot 140 via the terrain classification subsystem 124) and/or new information including the reclassification (e.g., generated at the computing device) indicating whether the unknown terrain is safe or unsafe.

In at least some implementations, the computing device may include more powerful computing resources than the robot 140, such as advanced model(s) (e.g., the model 118 such as a BEVFusion and/or BEVFormer model configured to classify terrain with high fidelity) or otherwise data processing capabilities and which may be unavailable locally on the robot 140 (e.g., due to computing resource constraints or the configuration of the robot 140). For example, the computing device may include the system 105 which stores a computational-heavy LIDAR data processing model (e.g., the model 118) which is unable to be executed at the robot 140 due to computing restraints of the robot 140. Returning again to FIG. 3B, the robot 140 may generate a request for new information associated with the third portion of terrain 316 that includes an associated third environmental dataset including point cloud of the third portion of terrain 316. The point cloud may indicate an object 324 in the third portion of terrain 316, however, the terrain classification subsystem 124 of the robot 140 may not be able to determine what the object 324 is (e.g., based upon the vision model stored on the robot 140) and therefore may be unable to generate an associated classification the third portion of terrain 316 causing the request for new information. Upon receiving the new information request, the system 105 may provide the third environmental dataset to the computational-heavy LIDAR data processing model of the terrain classification subsystem 124 of the system 105. The computational-heavy LIDAR data processing model may identify the object 324 as a traffic cone which does not pose a threat to the robot 140 traversing the third portion of terrain 316, causing the terrain classification subsystem 124 of the system 105 to classify the third portion of terrain 316 as safe. The system 105 (e.g., via the terrain classification application 132) may generate the new information associated with the third portion of terrain 316 that includes an indication the third portion of terrain 316 is reclassified as safe and transmit the new information to the robot 140 (e.g., via the network 110). Upon receipt of the new information (block 308), the robot 140 may reclassify the third portion of terrain 316 as safe.

Based upon the safe classification, the robot 140 may update (e.g., via the traversability update subsystem 128) the TKS 136 associated with the third portion of terrain 316 (block 310) with information associated with the reclassification (e.g., the third environmental dataset, the associated new information) and/or generate (e.g., via the task execution subsystem 130) a navigation path across the third portion of terrain 316 including a route that avoids the object 324. For example, when sufficient validation a terrain is safe is achieved via one or more of user feedback/confirmation, offboard (e.g., at the system 105) classification, probing, and/or temporal consistency, unknown terrain may be reclassified as safe within the TKS 136. In at least some implementations, the classification update of the terrain as safe in the TKS 136 may be provisional causing the associated terrain is labeled as safe but also causing the terrain to not be traversed by the robot 140 for navigation until further confirmation of the terrain takes place (e.g., at a later time via user feedback). The provisional classification can prevent an increase in the false negative rate of terrain classification and/or ensure safe operation of the robot 140 in unknown environments. The provisional classification of the terrain may include performing conformal prediction and/or associated calibrated uncertainty thresholds to maintain bounded false negative rates for safe classifications of terrain. Updates to the TKS 136 may be version-controlled, enabling the rollback to earlier TKS states if a risk arises, such as the risk a terrain was misclassified as safe when it is not. The combination of provisional validation, statistical guarantees, and rollback mechanisms ensures that expansion of terrain classified as safe in the TKS 136 does not compromise the safety of the robot 140 and/or its mission.

In at least some implementations, the terrain classification subsystem 124 and/or other components used during terrain classification, collectively referred to at times herein more generally as a “terrain classifier” or “classifier,” may be updated based upon information associated with the reclassification of terrain. For example, data associated with the computational-heavy LIDAR data processing model determining the object 324 as a traffic cone that does not pose a threat to the robot 140 may be used to update the terrain classification subsystem 124 of the local robot that was previously unable to identify object 324. Updating the terrain classification subsystem 124 of the robot 140 may include, for example, retraining the vision model stored on the robot 140 with data associated with the identification of the object 324 as the traffic cone and/or the reclassification of the third portion of terrain 322, such that the performance of the vision model and/or terrain classification subsystem 124 of the robot 140 is improved (e.g., the retrained vision model can successfully identify the 324 as a traffic cone).

In another example, the computing device may be the computing device 160. The robot 140 may generate a request for new information associated with classifying the fourth portion of the terrain 322 that includes associated fourth environmental dataset captured via the one or more sensors 150 including video and/or images of the fourth portion of terrain 322. In the example, the robot 140 may be able to identify the fourth portion of terrain 322 includes grass based upon analyzing the associated fourth environmental dataset, however, the on-board terrain classification subsystem 124 may be unable to identify a set of objects 326A, 326B because the set of objects 326A, 326B are too far from the robot 140 when capturing the fourth environmental dataset and not clearly depicted. The inability to identify the set of objects 326A, 326B may cause the robot 140 to be unable to classify the unknown fourth portion of terrain 322 as either unsafe or safe, and further to generate the request for new information associated with the fourth portion of terrain 322. The robot 140 may transmit the new information for the fourth portion of terrain 322 to the computing device 160.

FIG. 3C depicts an example first user interface 330 of the terrain classification application of the computing device in one implementation of the instant application. The first user interface 330 may display the images and video of the fourth portion of terrain 322 received in the associated new information request. The user of the computing device may determine from reviewing the first user interface 330 that the fourth portion of terrain 322 includes grass which the robot should not traverse. The first user interface 330 may include a communication interface 332 (e.g., chat interface) providing communication between the robot 140 and the user, for example via natural language. Based upon receiving the new information request, the communication interface 332 may indicate a request is received for new information associated with the fourth portion of terrain 322 that is classified unknown terrain in the displayed image 334. The user may type text in natural language format into the communication interface 332 that instructs the robot to avoid traveling on the grass, causing the computing device 160 to generate new information associated with the fourth portion of terrain 322 that includes the natural language text, and transmit the new information to the robot 140. The robot 140 may receive the new information associated with the fourth portion of terrain 322 (block 308). The robot may process the new information, for example using a language model of the terrain classification application 132. As the robot 140 previously determines the fourth portion of terrain 322 includes grass, the robot 140 is able to understand via natural language processing of the new information from the user that the fourth portion of terrain 322 should be reclassified as unsafe, even though the natural language text from the user did not explicitly instruct the robot 140 to reclassify the fourth portion of terrain 322 as unsafe. Based upon the unsafe reclassification, the robot 140 may update (e.g., via the traversability update subsystem 128) the TKS 136 associated with the fourth portion of terrain 322 (block 310) with information associated with the reclassification (e.g., the fourth environmental dataset, the associated new information) and/or generate (e.g., via the task execution subsystem 130) a navigation path that excludes the fourth portion of terrain 322 including a route that avoids the object 324. For example, FIG. 3D depicts an example second user interface 340 of the terrain classification application of the computing device in one implementation of the instant application. The second user interface 340 indicates via a second displayed image 336 that the fourth portion of terrain 322 is reclassified as unsafe based upon the new information provided by the user.

In at least some implementations, the terrain assessment task may include probing the terrain (e.g., via the robot 140) while keeping the robot 140 safe. Using the fourth portion of terrain 322 as an example before it was classified as unsafe, an associated terrain assessment task may include causing the robot to slowly approach the unknown set of objects 326A, 326B along a safe navigation path through the third portion of terrain 316. The robot 140 may approach the edge of the third portion of terrain 316 closest to the unknown set of objects 326A, 326B and capture updated fourth environmental data that may include new images and/or pictures from the edge of the third portion of terrain 316 which may more clearly capture the unknown set of objects 326A, 326B to probe the fourth portion of terrain 322. Probing the fourth portion of terrain 322 may include causing the robot 140 to slowly and safely sense the fourth portion of terrain 322, such as by sensing the fourth portion of terrain 322 using one or more proprioceptive sensors monitoring the force exerted on the fourth portion of terrain 322 (e.g., indicating its associated characteristics for supporting the robot). Probing the fourth portion of terrain 322 may include sensing wheel slippage via a friction coefficient and/or sinkage of the terrain based upon the probing as the robot slowly and safe encroaches on the section of the fourth portion of terrain 322, for example to detect whether the fourth portion of terrain 322 may be slick or muddy and cause navigation issues for the robot 140. The probing of the unknown section terrain may cause the section of terrain to be reclassified as safe or unsafe.

In at least some implementations, performance of one or more the terrain assessment tasks may be weighed against the ability of the robot 140 to perform its mission task. For example, determining whether to perform a terrain assessment task may be based upon whether a performance threshold is exceeded if the robot 140 performs the terrain assessment task. The performance threshold may be associated with an adverse effect on the robot 140 and/or the robot 140 performing a mission task. The performance threshold may be associated with one or more of: a delay in performing at least a portion of the mission task (e.g. performing the terrain assessment task must not cause the mission task to be delayed more than a certain amount of time), a non-completion of the mission task (e.g. performing the terrain assessment task may risk completion of the mission task to be delayed more than a certain amount of time), a usage of a resource (e.g., power, memory, processing cycles, network bandwidth) of the autonomous robot (e.g. performing the terrain assessment task may cause the robot to use more than a requite amount of computing resources such as battery power). If performing the terrain assessment task exceeds the performance threshold, the robot 140 may not perform the terrain assessment task.

Moreover, performing the classification or reclassification of a terrain may require a result having a particular false negative rate associated with misclassifying unsafe terrain as safe meeting certain criteria. The false negative rate may affect the upper bound on the expected failure rate of the robot. For example, misclassifying terrain as safe that is not safe may cause the robot to get stuck in the associated terrain risking completion of the mission task, cause the loss of the robot (e.g., if unable to free itself), and/or other adverse results. Accordingly, the ability to improve the classification of terrain and/or increase the terrain knowledge set (e.g., based upon new information) should not cause an increase in the false negative rate beyond one or more acceptable criteria and/or considerations.

It should be understood that scenarios, examples, etc., described in the aforementioned examples of FIGS. 3A-3D are for illustration purposes. Accordingly, functionalities attributed to one device, such as the robot 140, may be performed via suitable configured components of other devices, such as the system 105 and/or computing device 160. In example, a user of the system 105 may provide natural language feedback to the robot 140 rather than a user of the computing device 160. In another example, the terrain classification application 132 of the computing device 160 may cause reclassification of the terrain upon receiving new information from a user, rather than causing the robot 140 to reclassify the terrain based upon the associated new information.

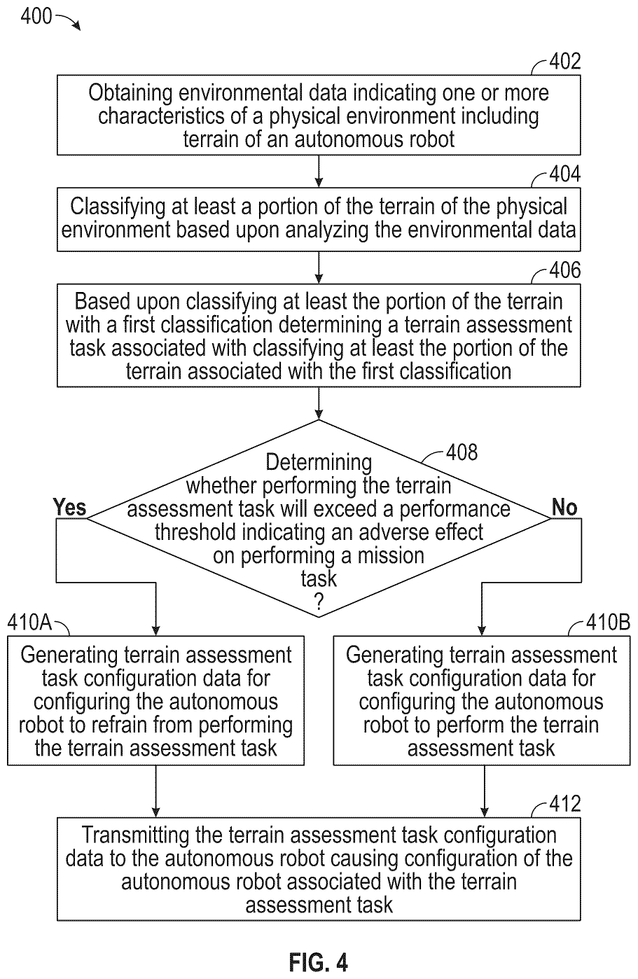

FIG. 4 is a flow diagram depicting an example computer-implemented method 400 for real-time terrain classification in one implementation of the instant application. One or more steps of the computer-implemented method 400 may be implemented as a set of instructions stored on a computer-readable memory and executable via one or more local or remote processors (e.g., the processor 102, 142, 162), computing devices (e.g., the system 105, the robot 140, the computing device 160), and/or other electronic or electrical components, which may be in wired or wireless communication with one another.

The exemplary computer-implemented method 400 may include obtaining (block 402) environmental data indicating one or more characteristics of a physical environment (e.g., the environment 320) including terrain of an autonomous robot (e.g. the robot 140). The autonomous robot may be fully autonomous, semiautonomous, an unmanned arial vehicle, or an unmanned terrestrial vehicle. The terrain may include one or more of: air, land, or water.

The exemplary computer-implemented method 400 may include classifying (block 404) at least a portion of the terrain of the physical environment based upon analyzing the environmental data. The classifying (block 404) may be performed substantially in real-time based upon evaluating the one or more characteristics of the physical environment indicated in the environmental data to determine whether at least the portion of the terrain is safe for the autonomous robot to successfully traverse. Classifying at least the portion of the terrain (block 404) may be performed via one or more of: semantic segmentation, a machine learning model, rules-based classification, or a geometric classification. Classifying at least the portion of the terrain (block 404) may not cause an increase of a false negative metric associated with classifying the terrain as safe for the autonomous robot to successfully traverse.

Based upon classifying at least the portion of the terrain with a first classification indicating no determination whether at least the portion of the terrain is safe for the autonomous robot to successfully traverse, the exemplary computer-implemented method 400 may include determining (block 406) a terrain assessment task associated with classifying at least the portion of the terrain associated with the first classification. Performing the terrain assessment task may include one or more of: storing data associated with classifying at least the portion of the terrain; transmitting, to a computing device, a request for new information associated with reclassifying at least the portion of the terrain associated with the first classification; or probing, via the autonomous robot, at least the portion of the terrain associated with the first classification.

The exemplary computer-implemented method 400 may include determining (block 408) whether performing the terrain assessment task will exceed a performance threshold indicating an adverse effect on performing a mission task. The performance threshold may be associated with one or more of: a delay in performing at least a portion of the mission task, a non-completion of the mission task, or a usage of a resource of the autonomous robot.

Based upon determining whether performing the terrain assessment task will exceed the performance threshold, the exemplary computer-implemented method 400 may include generating terrain assessment task configuration data for configuring the autonomous robot to either refrain from performing the terrain assessment task, or perform the terrain assessment task. In at least some implementations of the exemplary computer-implemented method 400, based upon determining the terrain assessment task will exceed the performance threshold, the exemplary computer-implemented method 400 includes generating (block 410A) terrain assessment task configuration data for configuring the autonomous robot to refrain from performing the terrain assessment task. In at least some implementations of the exemplary computer-implemented method 400, based upon determining performing the terrain assessment task will not exceed the performance threshold, the exemplary computer-implemented method 400 includes generating (block 410B) terrain assessment task configuration data is for configuring the autonomous robot to perform the terrain assessment task. In some such implementations, the exemplary computer-implemented method 400 may include obtaining terrain assessment task data associated with performing the terrain assessment task; reclassifying at least the portion of the terrain as safe or unsafe for the autonomous robot to successfully traverse based upon the terrain assessment task data; based upon reclassifying at least the portion of the terrain, generating mission configuration data for configuring the autonomous robot to perform the mission task; and transmitting the mission configuration data to the autonomous robot causing configuration of the autonomous robot for performing the terrain assessment task.

The exemplary computer-implemented method 400 may include transmitting (block 412) the terrain assessment task configuration data to the autonomous robot causing configuration of the autonomous robot associated with the terrain assessment task.

In at least some implementations, the exemplary computer-implemented method 400 may include, based upon classifying at least the portion of the terrain with a second classification indicating a determination that at least the portion of the terrain is safe for the autonomous robot to successfully traverse, generating a navigation path including at least the portion of the terrain associated with the second classification, and causing the autonomous robot to subsequently travel along the navigation path while performing the mission task.

In at least some implementations, the exemplary computer-implemented method 400 may include, based upon classifying at least the portion of the terrain with a third classification indicating a determination that the autonomous robot cannot safely traverse at least the portion of the terrain, generating a navigation path excluding at least the portion of the terrain associated with the third classification, and causing the autonomous robot to subsequently travel along the navigation path while performing the mission task.

It should be understood that not all blocks of the exemplary flow diagram of FIG. 4 are required to be performed.

While various embodiments and/or implementations have been described, the description is intended to be exemplary, rather than limiting, and it is understood that many more embodiments and/or implementations are possible that are within the scope of the embodiments and/or implementations. Although many possible combinations of features are shown in the accompanying figures and discussed in this detailed description, many other combinations of the disclosed features are possible. Any feature of any embodiment and/or implementation may be used in combination with or substituted for any other feature or element in any other embodiment and/or implementation unless specifically restricted. Therefore, it will be understood that any of the features shown and/or discussed in the present disclosure may be implemented together in any suitable combination. Accordingly, the embodiments and/or implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for real-time terrain classification via an autonomous robot, the system comprising:
the autonomous robot comprising one or more sensors configured to sense one or more characteristics of a physical environment including a terrain;
one or more processors; and
one or more memories having stored thereon processor-executable instructions that, when executed by the one or more processors, cause the one or more processors to:
obtain, via the one or more sensors, environmental data indicating the one or more characteristics of the physical environment of the autonomous robot sensed by the one or more sensors;
classify, via the autonomous robot, at least a portion of the terrain of the physical environment based upon analyzing the environmental data,
wherein classifying at least the portion of the terrain is performed substantially in real-time based upon evaluating the one or more characteristics of the physical environment indicated in the environmental data to determine whether at least the portion of the terrain is safe for the autonomous robot to successfully traverse; and
based upon classifying at least the portion of the terrain with a first classification indicating no determination whether at least the portion of the terrain is safe for the autonomous robot to successfully traverse, cause the autonomous robot to:
determine a terrain assessment task associated with classifying at least the portion of the terrain associated with the first classification;
determine whether performing the terrain assessment task will exceed a performance threshold indicating an adverse effect on the autonomous robot performing a mission task;
based upon determining performing the terrain assessment task will exceed the performance threshold, cause the autonomous robot to refrain from performing the terrain assessment task; and
based upon determining performing the terrain assessment task will not exceed the performance threshold, cause the autonomous robot to:
perform the terrain assessment task;
based upon performing the terrain assessment task, reclassify at least the portion of the terrain as safe or unsafe for the autonomous robot to successfully traverse; and
based upon reclassifying at least the portion of the terrain, cause the autonomous robot to perform the mission task.

2. The system of claim 1, wherein to perform the terrain assessment task, the one or more memories further comprise instructions that, when executed by the one or more processors, cause the one or more processors to one or more of:
store data associated with classifying at least the portion of the terrain;
transmit, to a computing device, a request for new information associated with reclassifying at least the portion of the terrain associated with the first classification; or
probe, via the autonomous robot, at least the portion of the terrain associated with the first classification.

3. The system of claim 2, the one or more memories further comprising instructions that, when executed by the one or more processors, cause the one or more processors to:
in response to transmitting the request for new information, receive, from the computing device, the new information, wherein the new information includes one or more of:
an indication of a reclassification of at least the portion of the terrain associated with the first classification; or
information provided via natural language text or natural language speech; and in response to receiving the new information, cause the autonomous robot to one or more of:
reclassify at least the portion of the terrain originally associated with the first classification based upon the new information; or
update a classifier of the autonomous robot that classifies the terrain of the physical environment.

4. The system of claim 1, wherein the autonomous robot classifies at least the portion of the terrain via one or more of: semantic segmentation, a machine learning model, rules-based classification, or a geometric classification.

5. The system of claim 1, wherein classifying at least a portion of the terrain does not cause an increase of a false negative metric associated with classifying the terrain as safe for the autonomous robot to successfully traverse.

6. The system of claim 1, the one or more memories further comprising instructions that, when executed by the one or more processors, cause the one or more processors to:
based upon classifying at least the portion of the terrain with a second classification indicating a determination that at least the portion of the terrain is safe for the autonomous robot to successfully traverse:
generate a navigation path including at least the portion of the terrain associated with the second classification, and
cause the autonomous robot to subsequently travel along the navigation path while performing the mission task.

7. The system of claim 1, the one or more memories further comprising instructions that, when executed by the one or more processors, cause the one or more processors to:
based upon classifying at least the portion of the terrain with a third classification indicating a determination that the autonomous robot cannot safely traverse at least the portion of the terrain:
generate a navigation path excluding at least the portion of the terrain associated with the third classification, and
cause the autonomous robot to subsequently travel along the navigation path while performing the mission task.

8. The system of claim 1, wherein the performance threshold is associated with one or more of: a delay in performing at least a portion of the mission task, a non-completion of the mission task, or a usage of a resource of the autonomous robot.

9. The system of claim 1, wherein the autonomous robot is one or more of: fully autonomous, semiautonomous, an unmanned arial vehicle, or an unmanned terrestrial vehicle.

10. The system of claim 1, wherein the terrain includes one or more of: air, land, or water.

11. A computer-implemented method for real-time terrain classification, the computer-implemented method comprising:
obtaining, via one or more processors, environmental data indicating one or more characteristics of a physical environment including terrain of an autonomous robot;
classifying, via the one or more processors, at least a portion of the terrain of the physical environment based upon analyzing the environmental data,
wherein classifying at least the portion of the terrain is performed substantially in real-time based upon evaluating the one or more characteristics of the physical environment indicated in the environmental data to determine whether at least the portion of the terrain is safe for the autonomous robot to successfully traverse; and
based upon classifying at least the portion of the terrain with a first classification indicating no determination whether at least the portion of the terrain is safe for the autonomous robot to successfully traverse:
determining, via the one or more processors, a terrain assessment task associated with classifying at least the portion of the terrain associated with the first classification;
determining, via the one or more processors, whether performing the terrain assessment task will exceed a performance threshold indicating an adverse effect on performing a mission task;
based upon determining whether performing the terrain assessment task will exceed the performance threshold, generating, via the one or more processors, terrain assessment task configuration data for configuring the autonomous robot to either:
refrain from performing the terrain assessment task; or
perform the terrain assessment task; and
transmitting, via the one or more processors, the terrain assessment task configuration data to the autonomous robot causing configuration of the autonomous robot associated with the terrain assessment task.

12. The computer-implemented method of claim 11, wherein:
based upon determining performing the terrain assessment task will exceed the performance threshold, the generated terrain assessment task configuration data is for configuring the autonomous robot to refrain from performing the terrain assessment task.

13. The computer-implemented method of claim 11, wherein:
based upon determining performing the terrain assessment task will not exceed the performance threshold, the generated terrain assessment task configuration data is for configuring the autonomous robot to perform the terrain assessment task; and
the computer-implemented method further comprises:
obtaining, via the one or more processors, terrain assessment task data associated with performing the terrain assessment task;
reclassifying, via the one or more processors, at least the portion of the terrain as safe or unsafe for the autonomous robot to successfully traverse based upon the terrain assessment task data;
based upon reclassifying at least the portion of the terrain, generating, via the one or more processors, mission configuration data for configuring the autonomous robot to perform the mission task; and
transmitting, via the one or more processors, the mission configuration data to the autonomous robot causing configuration of the autonomous robot for performing the terrain assessment task.

14. The computer-implemented method of claim 11, wherein performing the terrain assessment task includes one or more of:
storing, by the one or more processors, data associated with classifying at least the portion of the terrain;
transmitting, by the one or more processors to a computing device, a request for new information associated with reclassifying at least the portion of the terrain associated with the first classification; or
probing, by the one or more processors via the autonomous robot, at least the portion of the terrain associated with the first classification.

15. The computer-implemented method of claim 11, wherein classifying at least the portion of the terrain is performed via one or more of: semantic segmentation, a machine learning model, rules-based classification, or a geometric classification.

16. The computer-implemented method of claim 11, wherein classifying at least a portion of the terrain does not cause an increase of a false negative metric associated with classifying the terrain as safe for the autonomous robot to successfully traverse.

17. The computer-implemented method of claim 11, further comprising one or more of:
based upon classifying at least the portion of the terrain with a second classification indicating a determination that at least the portion of the terrain is safe for the autonomous robot to successfully traverse:
generating, by the one or more processors, a navigation path including at least the portion of the terrain associated with the second classification, and
causing, by the one or more processors, the autonomous robot to subsequently travel along the navigation path while performing the mission task; or
based upon classifying at least the portion of the terrain with a third classification indicating a determination that the autonomous robot cannot safely traverse at least the portion of the terrain:
generating, by the one or more processors, a navigation path excluding at least the portion of the terrain associated with the third classification, and
causing, by the one or more processors, the autonomous robot to subsequently travel along the navigation path while performing the mission task.

18. The computer-implemented method of claim 11, wherein the performance threshold is associated with one or more of: a delay in performing at least a portion of the mission task, a non-completion of the mission task, or a usage of a resource of the autonomous robot.

19. The computer-implemented method of claim 11, wherein the autonomous robot is one or more of: fully autonomous, semiautonomous, an unmanned arial vehicle, or an unmanned terrestrial vehicle.

20. A non-transitory computer-readable medium storing processor-executable instructions that, when executed by one or more processors, cause the one or more processors to:
obtain environmental data indicating one or more characteristics sensed via one or more sensors of a physical environment including terrain of an autonomous robot;
classify at least a portion of the terrain of the physical environment based upon analyzing the environmental data,
wherein classifying at least the portion of the terrain is performed substantially in real-time based upon evaluating the one or more characteristics of the physical environment indicated in the environmental data to determine whether at least the portion of the terrain is safe for the autonomous robot to successfully traverse; and
based upon classifying at least the portion of the terrain with a first classification indicating no determination whether at least the portion of the terrain is safe for the autonomous robot to successfully traverse:
determine a terrain assessment task associated with classifying at least the portion of the terrain associated with the first classification;
determine whether performing the terrain assessment task will exceed a performance threshold indicating an adverse effect on performing a mission task;
based upon determining whether performing the terrain assessment task will exceed the performance threshold, generate terrain assessment task configuration data for configuring the autonomous robot to either:
refrain from performing the terrain assessment task; or
perform the terrain assessment task; and
transmit the terrain assessment task configuration data to the autonomous robot causing configuration of the autonomous robot associated with the terrain assessment task.
